(19) United States
(12) Patent Application Publication
(10) Pub. No.: US 2026/0319166 A1
(43) Pub. Date: Oct. 15, 2026

(54) OPTICAL FIBER, COLORED OPTICAL FIBER, AND OPTICAL FIBER RIBBON

(71) Applicant: Lightera Japan Co., Ltd., Tokyo (JP)

(72) Inventors: Kuniaki ISHIZUKI, Tokyo (JP); Mitsuhiro IWAYA, Tokyo (JP); Takahiro SAKURAI, Tokyo (JP)

(73) Assignee: Lightera Japan Co., Ltd., Tokyo (JP)

(21) Appl. No.: 19/570,781

(22) Filed: Mar. 18, 2026

(30) Foreign Application Priority Data
Apr. 15, 2025 (JP) 2025-067003

(51) Int. Cl. G02B 6/02; G02B 6/44

(52) U.S. Cl. CPC G02B 6/02395; G02B 6/443; G02B 6/448; G02B 6/4482; G02B 6/4486

(57) ABSTRACT

An optical fiber according to the present invention includes a bare optical fiber, a primary layer that is formed of a first ultraviolet curing resin composition and covers the bare optical fiber, and a secondary layer that is formed of a second ultraviolet curing resin composition and covers the primary layer, wherein at least one type of chemical bond with a bond energy of less than 259 kJ/mol is introduced into at least one of a first interface between the bare optical fiber and the primary layer, and a second interface between the primary layer and the secondary layer.

### CROSS-REFERENCE TO RELATED APPLICATIONS

This application claims the benefit of priority to Japanese Patent Application No. 2025-067003, filed on Apr. 15, 2025, the entire contents of which are incorporated herein by reference.

### BACKGROUND OF THE INVENTION

### Field of the Invention

The present invention relates to an optical fiber, a colored optical fiber, and an optical fiber ribbon.

### Description of the Related Art

A technique is known in which each of a primary layer covering a bare optical fiber, a secondary layer covering the primary layer, and a colored layer covering the secondary layer is formed by using an ultraviolet curing resin in optical fibers (Japanese Patent Laid-Open No. 2005-162522). Furthermore, a technique is known in which forming the primary layer from a soft material with a low Young's modulus mitigates the forces applied to the bare optical fiber and suppresses microbend loss (WO2018/062364).

### SUMMARY OF THE INVENTION

However, lowering the Young's modulus of the primary layer may reduce its ability to hold the optical fiber. Therefore, a method to reduce microbend loss other than adjusting the Young's modulus of the primary layer has been sought.

Accordingly, the present invention intends to provide an optical fiber, a colored optical fiber, and an optical fiber ribbon capable of reducing microbend loss, in light of the aforementioned issues.

According to one aspect of the present invention, provided is an optical fiber including: a bare optical fiber; a primary layer that is formed of a first ultraviolet curing resin composition and covers the bare optical fiber; and a secondary layer that is formed of a second ultraviolet curing resin composition and covers the primary layer, wherein at least one type of chemical bond with a bond energy of less than 259 kJ/mol is introduced into at least one of a first interface between the bare optical fiber and the primary layer, and a second interface between the primary layer and the secondary layer.

According to the present invention, it is possible to provide an optical fiber, a colored optical fiber, and an optical fiber ribbon that can reduce microbend loss.

### BRIEF DESCRIPTION OF THE DRAWINGS

FIG. 1 is a cross-sectional view of a colored optical fiber according to an embodiment.

FIG. 2 is a cross-sectional view of a coated optical fiber according to the embodiment.

FIG. 3 is a schematic diagram illustrating a manufacturing apparatus used in a method for manufacturing the colored optical fiber according to the embodiment.

FIG. 4 is a schematic diagram illustrating a manufacturing apparatus used in the method for manufacturing the colored optical fiber according to the embodiment.

FIG. 5 is a cross-sectional view of an optical fiber ribbon according to the embodiment.

FIG. 6 is a schematic diagram of a ribbon forming apparatus used in a method for manufacturing the optical fiber ribbon according to the embodiment.

FIG. 7 is a flowchart of a method for manufacturing the colored optical fiber and the optical fiber ribbon according to the embodiment.

FIG. 8 is a diagram illustrating results of a delamination recovery test in an example of the coated optical fiber according to the embodiment.

FIG. 9 is a diagram illustrating results of a delamination recovery test in a comparative example of the coated optical fiber according to the embodiment.

### DESCRIPTION OF THE EMBODIMENTS

Hereinafter, embodiments of the present invention will be described in detail with reference to the drawings. Throughout the drawings, components having the same function are labeled with the same references, and the repetitive description thereof may be omitted.

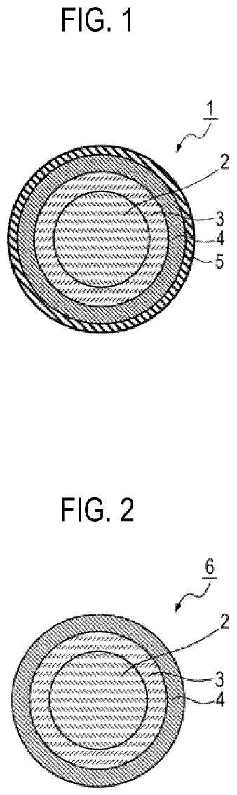

FIG. 1 is a cross-sectional view of a colored optical fiber 1 according to the present embodiment. The colored optical fiber 1 includes a bare optical fiber 2, a primary layer 3 covering the outer periphery of the bare optical fiber 2, a secondary layer 4 covering the outer periphery of the primary layer 3, and a colored layer 5 covering the outer periphery of the secondary layer 4. The bare optical fiber 2 is covered with three covering layers of the primary layer 3, the secondary layer 4, and the colored layer 5. FIG. 2 is a cross-sectional view of the coated optical fiber 6 according to the present embodiment. The coated optical fiber 6 is a fiber in a state before the colored layer 5 is formed. In this specification, the coated optical fiber 6 is also referred to as the “optical fiber”.

The bare optical fiber 2 is formed of quartz glass or the like, for example, and transmits light. In the present specification, the bare optical fiber 2 is also simply referred to as “glass”. The primary layer 3, the secondary layer 4, and the colored layer 5 are each formed by curing an ultraviolet curing resin by irradiation with ultraviolet light (UV). The ultraviolet irradiation is performed, for example, by using a mercury lamp or a UV-LED at an appropriate illuminance and irradiation dose as needed.

The primary layer 3 is a soft layer and has a function of buffering an external force applied to the bare optical fiber 2. The secondary layer 4 is a hard layer and has a function of protecting the bare optical fiber 2 and the primary layer 3 from an external force.

The colored layer 5 is a layer colored to identify the colored optical fiber 1. The colored secondary layer 4 may be the outermost layer of the colored optical fiber 1. When the secondary layer 4 is colored, the secondary layer 4 is colored by adding a coloring agent obtained by mixing a pigment, a lubricant, or the like is added to the secondary layer 4. The content of the coloring agent in the colored secondary layer 4 can be appropriately determined depending on the content of the coloring agent contained in the coloring agent, the kind of other components, such as the ultraviolet curing resin, or the like.

In the present embodiment, the primary layer 3, the secondary layer 4, and the colored layer 5 are formed of a composition (hereinafter, this is referred to as “ultraviolet curing resin composition”) containing an ultraviolet curing resin as a main component. The ultraviolet curing resin is, for example, a urethane acrylate (methacrylate)-based ultraviolet curing resin. The urethane acrylate (methacrylate)-based ultraviolet curing resin is composed of an oligomer, a monomer, or the like. The ultraviolet curing resin composition appropriately contains additives such as a photoinitiator, a photosensitizer, a chain transfer agent, an ultraviolet absorber, an antioxidant, a silane coupling agent, a lubricant such as silicone, and a pigment such as titanium oxide. The physical properties, such as the conversion rate, Young's modulus, and elongation at break, can be controlled by appropriately adjusting the components of the ultraviolet curing resin composition.

Examples of the photo initiator include 1-hydroxycyclohexyl-phenyl ketone, 2,4,6-trimethylbenzoyl-diphenylphosphine oxide, 2,4,6-trimethylbenzoyl bis(p-tolyl) phosphine oxide, Ethyl phenyl(2,4,6-trimethylbenzoyl)phosphonate, bis(2,4,6-trimethylbenzoyl)phenylphosphine oxide, 2-methyl-1-[4-(methylthio)phenyl]-2-morpholinopropan-1-one) and the like. The type of the photoinitiator is not limited to those described above.

By adding a photoinitiator or a photosensitizer, UV curing can be efficiently performed. This is particularly effective for curing using a UV-LED. Examples of the photoinitiator having an absorption region at a wavelength of 300 nm or more include 2,4,6-trimethylbenzoyl-diphenylphosphine oxide, 2,4,6-trimethylbenzoyl bis(p-tolyl) phosphine oxide, and bis(2,4,6-trimethylbenzoyl)phenylphosphine oxide. Examples of the photosensitizer having an absorption region at a wavelength of 300 nm or more include 2,4-diethyl-9H-thioxanthen-9-one, 2-isopropylthioxanthone and the like.

The optical fiber of the present embodiment is characterized by introducing a weak bond at least at one of the interfaces between the optical fiber glass (bare optical fiber 2) and the primary layer 3, or between different covering layers. When the weak bond forms a sacrificial bond, external stress can sever the weak bond, thereby dissipating the external stress. Furthermore, while the weak bonds can be either “irreversible bond” or “reversible bond”, the following explanation uses “reversible bond” as an example of a weak bond. However, the “weak bond” is not necessarily limited to reversible bond. The Weak bond may also be “irreversible bond”.

As a material for forming the primary layer 3, an ultraviolet curing resin composition obtained by adding a silane coupling agent to an ultraviolet curing resin is used. A typical silane coupling agent has a functional group for irreversibly bonding the bare optical fiber 2 and the primary layer 3. By adding the silane coupling agent to the ultraviolet curing resin, the bare optical fiber 2 and the primary layer 3 are sufficiently adhered to each other. In the present embodiment, the term “irreversible bond” indicates a bond that does not cause recombination once cleaved. Irreversible bonds include, for example, covalent bonds such as carbon-carbon covalent bonds and carbon-sulfur covalent bonds. Therefore, when the silane coupling agent is added to the ultraviolet curing resin, if the bond is once cut by an external stimulus or the like, the portion cannot be recombined.

Examples of the general silane coupling agent include (3-mercaptopropyl)trimethoxysilane, (3-mercaptopropyl) triethoxysilane, vinyltrimethoxysilane, allyltrimethoxysilane, 3-(trimethoxysilyl)propyl methacrylate, and (3-isocyanatopropyl)trimethoxysilane). The type of the silane coupling agent is not limited thereto.

In addition, in the present embodiment, the term “reversible bond” indicates a bond that can recombined again even if it is once cleaved. Examples of the reversible bond include a hydrogen bond, a dynamic covalent bond, an ionic bond, and a bond by an intermolecular force. In the present embodiment, as a material for forming the primary layer 3, an ultraviolet curing resin composition to which a silane coupling agent for reversibly bonding the cured primary layer 3 and the bare optical fiber 2 is added is used. When introducing “reversible bond” as a weak bond, there is the advantage that even if the bond is severed due to external stimuli, recombination can occur, allowing delamination to be restored, while ensuring sufficient contact between the bare optical fiber 2 and the primary layer 3.

As the silane coupling agent of the present embodiment, a silane coupling agent having a portion where a urethane bond is formed and a portion to form a hydrogen bond in the ultraviolet curing resin constituting the primary layer 3 can be considered. The hydrogen bond is an interaction formed by a hydrogen atom covalently bonded to an atom having a high electronegativity (e.g., nitrogen, oxygen, sulfur, chlorine, or fluorine) and a lone electron pair of an atom having a high electronegativity. In the molecular structure of the silane coupling agent, examples of the portion that forms a hydrogen bond with the portion where a urethane bond is formed in the primary layer 3 include a functional group such as a carboxy group, a hydroxy group, or an ester group, and a portion where a urethane bond or a urea bond is formed.

The method for forming the reversible bond is not limited to the above-described method. For example, a functional group capable of forming the reversible bond may be introduced in advance into both of the ultraviolet curing resin constituting the primary layer 3 and the silane coupling agent. For example, a bond-exchangeable dynamic bond, such as a disulfide bond or diarylbibenzofuranone, may be introduced into both the ultraviolet curing resin and the silane coupling agent. Furthermore, a molecular structure in which a predetermined portion of the ultraviolet curing resin and a predetermined portion of the silane coupling agent can be reversibly bonded (bonded by ionic bond or intermolecular force) may be incorporated into one or both of the ultraviolet curing resin and the silane coupling agent.

In addition, to accelerate the reaction between the silane coupling agent and the bare optical fiber 2, an additive (photoacid generator) that generates an acid upon ultraviolet irradiation may be appropriately added. Examples of the photoacid generator include CPI-200K, manufactured by San-Apro. The type of the photoacid generator is not limited thereto.

In order to adjust the Young's modulus of the ultraviolet curing resin, a mercapto-containing compound may be added. Examples of mercapto-containing compounds include isooctyl 3-mercaptopropionate, ethyl mercaptan, 1-butanethiol, 1-heptanethiol, 1-undecanethiol, 4-hydroxybenzenethiol, (2-mercaptoethyl) pyrazine, 2,3-butanedithiol, 3-methyl-2-butanethiol, 3-mercapto-1,2,4-triazole, 1,3,4-thiadiazole-2-thiol, isobutyl mercaptan, 4-methoxy-α-toluenethiol, 4,4′-biphenyldithiol, trimethylsilylmethanethiol, 1,4-butanedithiol, 1,8-octanedithiol, 3-ethoxybenzenethiol, pentaerythritol tetra(3-mercaptopropionate)), and the like. The kind of mercapto-containing compound is not limited thereto. In addition, not only the mercapto-containing compound but also a compound that reacts with the ultraviolet curing resin to stop polymerization may be added.

The diameter of the coated optical fiber 6 may be greater than or equal to 80 μm and less than or equal to 150 μm, and preferably greater than or equal to 124 μm and less than or equal to 126 μm. The thickness of the primary layer may be greater than or equal to 5 μm and less than or equal to 60 μm. The thickness of the secondary layer may be greater than or equal to 5 μm and less than or equal to 60 μm. The thickness of the colored layer may be about several micrometers.

Here, the diameter of the coated optical fiber 6 can be determined by the sum of the diameter of the bare optical fiber 2, the length twice the thickness of the primary layer 3, and the length twice the thickness of the secondary layer 4. Therefore, the diameter of the bare optical fiber 2, the thickness of the primary layer 3, and the thickness of the secondary layer 4 can be selected so that the diameter of the coated optical fiber 6 is about 120 to 280 μm.

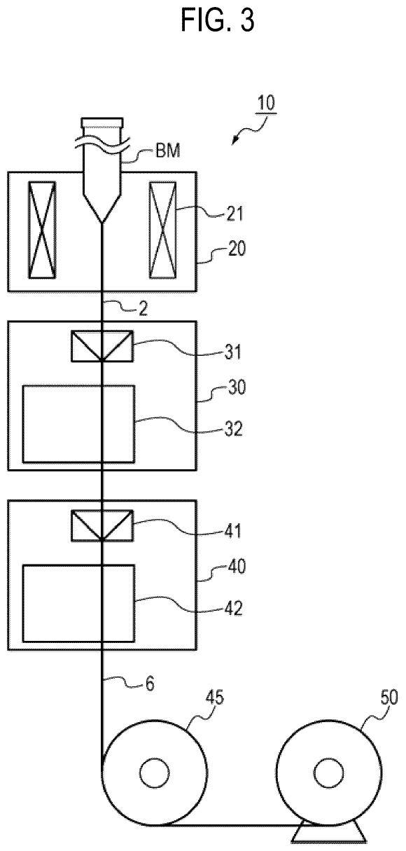

FIG. 3 is a schematic diagram illustrating a manufacturing apparatus 10 used in a method for manufacturing the coated optical fiber 6 according to the present embodiment. In FIG. 3, the manufacturing apparatus 10 includes a heating apparatus 20, a primary layer covering apparatus 30, a secondary layer covering apparatus 40, a guide roller 45, and a winding apparatus 50.

The optical fiber preform BM is made of, for example, quartz-based glass, and is manufactured by a well-known method such as a VAD method, an OVD method, or an MCVD method. The heating apparatus 20 includes a heater 21. The heater 21 may be any heat source, such as a tape heater, a ribbon heater, a rubber heater, an oven heater, a ceramic heater, a halogen heater, or the like. The end portion of the optical fiber preform BM is heated and melted by using the heater 21 arranged around the optical fiber preform BM, and a bare optical fiber 2 is drawn by drawing.

Under the heating apparatus 20, a primary layer covering apparatus 30 is provided. The primary layer covering apparatus 30 includes a resin application apparatus 31 and an ultraviolet irradiation apparatus 32. The resin application apparatus 31 holds an ultraviolet curing resin composition (hereinafter, this is referred to as “primary layer material”) as a covering material for forming the primary layer 3. The primary layer material is applied to the bare optical fiber 2 drawn from the optical fiber preform BM by the resin application apparatus 31.

The ultraviolet irradiation apparatus 32 is provided under the resin application apparatus 31. The ultraviolet irradiation apparatus 32 includes any ultraviolet light source such as a metal halide lamp, a mercury lamp, or a UV-LED. The primary layer material is applied to the bare optical fiber 2 by the resin application apparatus 31 and the bare optical fiber 2 enters the ultraviolet irradiation apparatus 32, and the primary layer material is irradiated with ultraviolet light. As a result, the primary layer material is cured to form the primary layer 3.

Under the primary layer covering apparatus 30, the secondary layer covering apparatus 40 is provided. The secondary layer covering apparatus 40 includes a resin application apparatus 41 and an ultraviolet irradiation apparatus 42. The resin application apparatus 41 holds an ultraviolet curing resin composition (hereinafter, this is referred to as a “secondary layer material”) as a covering material for forming the secondary layer 4. The secondary layer material is applied to the primary layer 3 by the resin application apparatus 41.

The ultraviolet irradiation apparatus 42 is provided under the resin application apparatus 41. The ultraviolet irradiation apparatus 42 may have a configuration similar to that of the ultraviolet irradiation apparatus 32. The bare optical fiber 2 covered with the secondary layer material enters the ultraviolet irradiation apparatus 42, and the secondary layer material is irradiated with ultraviolet light. As a result, the secondary layer material is cured to form the secondary layer 4. The coated optical fiber 6 is formed by covering the bare optical fiber 2 with the primary layer 3 and the secondary layer 4.

The resin application apparatus 31 may be configured to separately hold the primary layer material and the secondary layer material. In this case, the resin application apparatus 31 applies the primary layer material to the bare optical fiber 2, and subsequently applies the secondary layer material on the primary layer material.

The ultraviolet irradiation apparatus 32 irradiates the primary layer material and the secondary layer material applied to the bare optical fiber 2 with ultraviolet light. Thus, the primary layer 3 and the secondary layer 4 are formed. In this case, the manufacturing s 10 does not necessarily need to have the secondary layer covering apparatus 40.

The guide roller 45 and the winding apparatus 50 are provided under the secondary layer covering apparatus 40. The manufactured coated optical fiber 6 is guided by the guide roller 45 and wound by the winding apparatus 50.

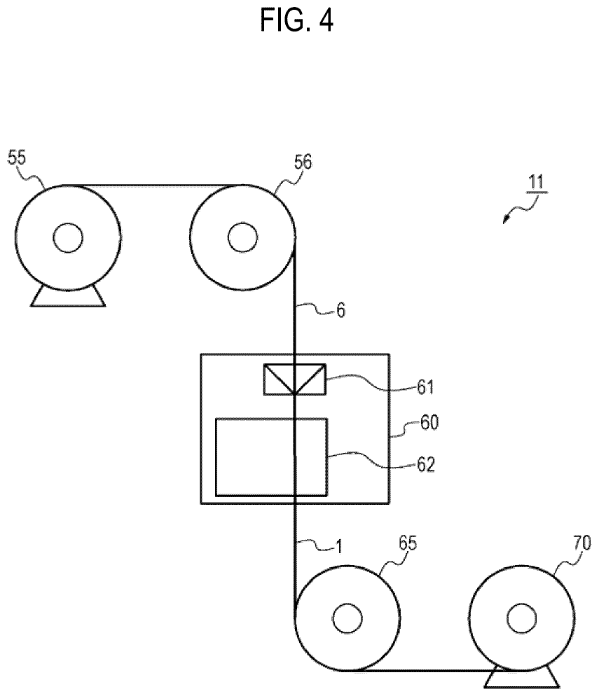

FIG. 4 is a schematic diagram illustrating a manufacturing apparatus 11 used in the method for manufacturing the colored optical fiber 1 according to the present embodiment. In FIG. 4, the manufacturing apparatus 11 includes a coated optical fiber holding apparatus 55, a guide roller 56, a colored layer covering apparatus 60, a guide roller 65, and a winding apparatus 70. The manufacturing apparatus 11 manufactures the colored optical fiber 1 from the coated optical fiber 6 manufactured by the plurality of manufacturing apparatuses 10 illustrated in FIG. 3.

The coated optical fiber holding apparatus 55 holds the manufactured coated optical fiber 6 in a wound state. In FIG. 4, the coated optical fiber holding apparatus 55 is a different apparatus from the winding apparatus 50, but the winding apparatus 50 may also serve as the coated optical fiber holding apparatus 55.

The colored layer covering apparatus 60 is provided under the coated optical fiber holding apparatus 55. The coated optical fiber 6 pulled out from the coated optical fiber holding apparatus 55 is guided by the guide roller 56 provided between the coated optical fiber holding apparatus 55 and the colored layer covering apparatus 60, and is conveyed into the colored layer covering apparatus 60.

The colored layer covering apparatus 60 includes a resin application apparatus 61 and an ultraviolet irradiation apparatus 62. The resin application apparatus 61 holds an ultraviolet curing resin composition (hereinafter, this is referred to as “colored layer material”) as a covering material for forming the colored layer 5.

The colored layer material is applied to the coated optical fiber 6 by the resin application apparatus 61. The ultraviolet irradiation apparatus 62 is provided under the resin application apparatus 61. The ultraviolet irradiation apparatus 62 may be configured in the same manner as the ultraviolet irradiation apparatuses 32 and 42.

The coated optical fiber 6 covered with the colored layer material on the outer periphery of the secondary layer 4 enters the ultraviolet irradiation apparatus 62, and the colored layer material and the coated optical fiber 6 are irradiated with ultraviolet light. Thus, the colored layer material is cured to form the colored layer 5.

The colored optical fiber 1 is formed by covering the bare optical fiber 2 with the primary layer 3, the secondary layer 4, and the colored layer 5. The manufactured colored optical fiber 1 is guided by the guide roller 65 provided under the colored layer covering apparatus 60 and wound around the winding apparatus 70.

FIG. 5 is a cross-sectional view of the optical fiber ribbon 100 according to the present embodiment. The optical fiber ribbon 100 is configured by bundling a plurality of colored optical fibers 1 in a band shape via a ribbon layer 101.

The ribbon layer 101 is formed by irradiating a covering material containing an ultraviolet curing resin with ultraviolet light to cure t the covering material. The ultraviolet curing resin forming the ribbon layer 101 is formed of the same resin as the ultraviolet curing resin forming the primary layer 3, the secondary layer 4, and the colored layer 5. The colored optical fiber 1 can be bundled at a high density by taking the form of the optical fiber ribbon 100. The optical fiber ribbon 100 is not limited to the configuration illustrated in FIG. 5. For example, the optical fiber ribbon 100 may be configured as an intermittently bonded ribbon. The intermittently bonded ribbon is a ribbon configuration in which multiple optical fibers are connected intermittently in parallel along the longitudinal direction. It may also take the form of an optical fiber ribbon cable in which the optical fiber ribbon 100 is housed by a sheath.

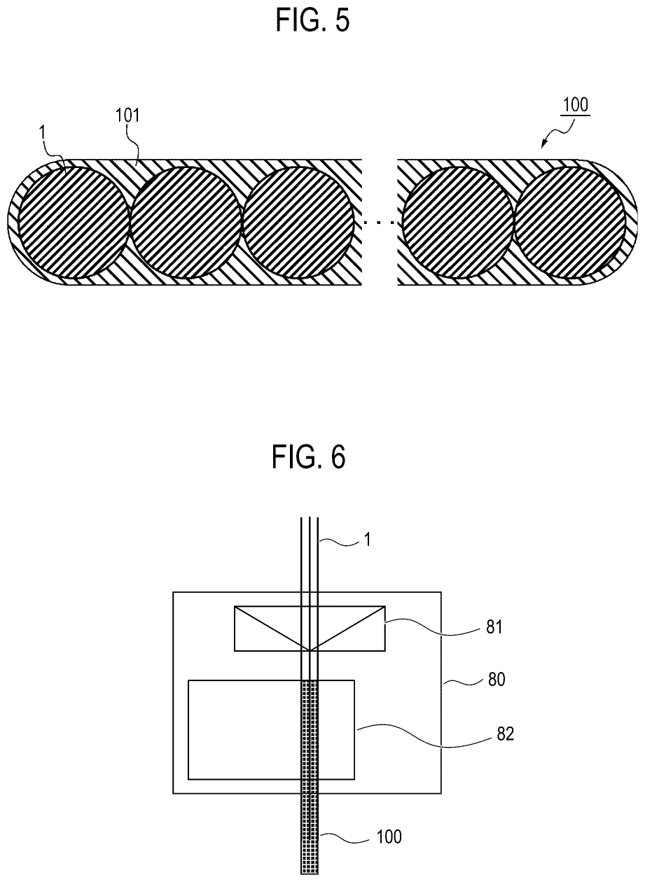

FIG. 6 is a schematic diagram of a ribbon forming apparatus 80 used in a method for manufacturing the optical fiber ribbon 100 according to the present embodiment. The ribbon forming apparatus 80 includes a resin application apparatus 81 and an ultraviolet light source 82. The resin application apparatus 81 holds an ultraviolet curing resin composition (hereinafter, this is referred to as “ribbon layer material”), which is a covering material of the ribbon layer 101.

A plurality of prepared colored optical fibers 1 enter the ribbon forming apparatus 80 in a parallel arrangement, and the ribbon layer material is applied by the resin application apparatus 81. The colored optical fiber 1 applied to the ribbon layer material is bundled together with a plurality of other colored optical fibers 1 applied to the ribbon layer material. The bundled plurality of colored optical fibers 1 are irradiated with ultraviolet light by the ultraviolet light source 82 provided in the ribbon forming apparatus 80. As a result, the ribbon layer material is cured to form the ribbon layer 101. A plurality of colored optical fibers 1 arranged in parallel are connected via the ribbon layer 101. In this way, the optical fiber ribbon 100 is formed from the colored optical fibers 1 having a small diameter.

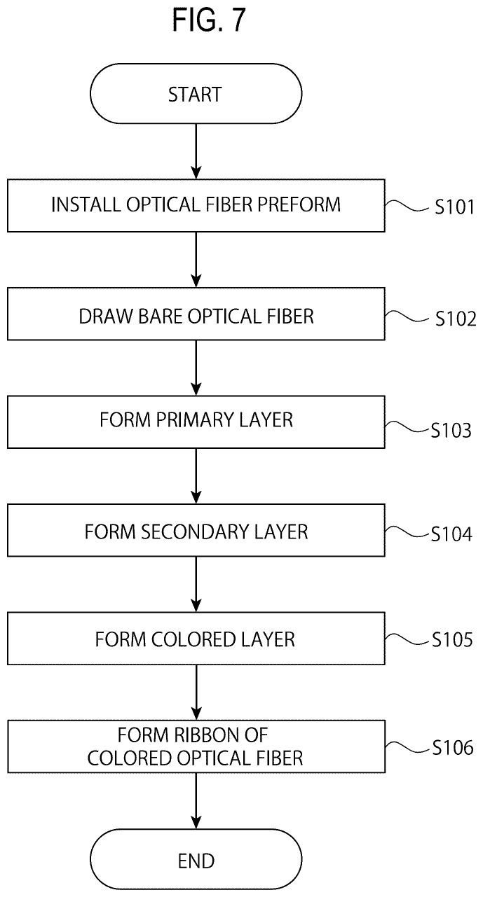

FIG. 7 is a flowchart of a method for manufacturing the colored optical fiber 1 and the optical fiber ribbon 100 according to the present embodiment. First, a user installs the optical fiber preform BM in the manufacturing apparatus 10 (step S101).

Next, the heater 21 provided in the heating apparatus 20 heats the optical fiber preform BM and starts drawing the bare optical fiber 2 (step S102).

The primary layer covering apparatus 30 applies the primary layer material around the drawn bare optical fiber 2 and irradiates the primary layer material with ultraviolet light to form the primary layer 3 (step S103).

Next, the secondary layer covering apparatus 40 applies the secondary layer material around the primary layer 3 and irradiates the secondary layer material with ultraviolet light to form the secondary layer 4 (step S104). Thus, the coated optical fiber 6 is obtained. The manufactured coated optical fiber 6 is wound by the winding apparatus 50.

Subsequently, when the coated optical fiber 6 is pulled out from the coated optical fiber holding apparatus 55 or the winding apparatus 50, the colored layer covering apparatus 60 applies the colored layer material around the secondary layer 4 of the coated optical fiber 6 and irradiates the colored layer material with ultraviolet light to form the colored layer 5 (step S105). By covering the colored layer 5 around the coated optical fiber 6, the colored optical fiber 1 is obtained. The manufactured colored optical fiber 1 is wound around the winding apparatus 70.

In the step of forming the primary layer 3 (step S103), ultraviolet irradiation is not necessarily required. In this case, the primary layer 3 can be cured in the step of forming the secondary layer 4 (step S104).

After the colored layer 5 is formed in step S105, the ribbon forming apparatus 80 applies the ribbon layer material so as to cover the plurality of colored optical fibers 1 in a parallel arrangement, and forms the ribbon layer 101 by irradiating the ribbon layer material with ultraviolet light to cure it. By connecting the plurality of colored optical fibers 1 to each other using the ribbon layer 101, the optical fiber ribbon 100 is manufactured (step S106) The structure of the optical fiber ribbon 100 is not limited to that described above, as long as a plurality of colored optical fibers 1 are gathered. In FIG. 7, in the step of forming the primary layer 3 (step S103), the primary layer material is irradiated with ultraviolet light to cure the primary layer material, but the irradiation timing is not limited thereto. In the step of forming the secondary layer 4 (step S104), the primary layer material and the secondary layer material may be cured by irradiating the primary layer material and the secondary layer material with ultraviolet light.

Further, the Young's modulus measurement (P-ISM) of the primary layer 3 is defined as having been measured by the following method. First, using a commercially available stripper, the primary layer 3 and the secondary layer 4 of the intermediate portion of the optical fiber serving as a sample are peeled off by a length of several millimeters, and then one end of the optical fiber on which the covering layer is formed is fixed on the slide glass with an adhesive, and a load F is applied to the other end of the optical fiber on which the covering layer is formed. In this state, a displacement & of the primary layer 3 at the boundary between the portion where the covering layer is peeled off and the portion where the covering layer is formed is read by a microscope. Then, by setting the load F to 10, 20, 30, 50, and 70 gf (that is, 98, 196, 294, 490, and 686 mN sequentially), a graph of the displacement d with respect to the load F is created. Then, the primary elastic modulus is calculated using the slope obtained from the graph and the following equation (1). Since the calculated primary elastic modulus corresponds to the so-called ISM, the primary elastic modulus is appropriately referred to as P-ISM in the following description. When drawing the colored optical fiber 1, the drawing speed and the illuminance of the ultraviolet were controlled in order to adjust the P-ISM.

P−ISM=(3F/δ)*(1/2πl)*ln(DP/DG) equation (1)

Here, the unit of P-ISM is [MPa]. Further, F/δ is an inclination indicated by a graph of the displacement (δ) [μm] with respect to the load (F) [gf], l is a sample length (for example, 10 mm), and DP/DG is a ratio between the outer diameter (DP) [μm] of the primary layer 3 and the outer diameter (DG) [μm] of the cladding portion of the optical fiber. Therefore, in the case of calculating P-ISM from F, δ, and l used, it is necessary to perform predetermined unit conversion. The outer diameter of the primary layer 3 and the outer diameter of the cladding portion can be measured by observing the cross section of the optical fiber cut by a fiber cutter with a microscope. In general, the Young's modulus of the primary layer 3 may be in the range of 0.1 to 3.0 MPa.

A method for measuring the Young's modulus of the secondary layer 4 is as follows. The optical fiber is immersed in liquid nitrogen, and the covering is stripped by a stripper to pull out the glass optical fiber from the optical fiber, thereby preparing a covering-only sample. Next, the end portion of the sample is fixed to an aluminum plate with an adhesive. Next, a portion of the aluminum plate is chucked in an atmosphere having a temperature of 23° C. and a relative humidity of 50% using a Tensilon universal tensile tester. Next, the sample is pulled at a marking interval of 25 mm and a pulling rate of 1 mm/min, and the force at the time of 2.5% stretching is measured. Then, an elastic modulus (secondary elastic modulus) S-ISM (2.5% secant modulus) of the secondary layer is calculated based on the measured value. In general, the Young's modulus of the secondary layer 4 can be in the range of 500 to 2000 MPa.

When the colored layer 5 of the colored optical fiber 1 is formed, an ultraviolet curing resin composition containing a coloring ink is used. Examples of the color of the coloring ink include black, gray, purple, blue, aqua, green, yellow, orange, brown, pink, red, and white. In general, the Young's modulus of the colored layer 5 can be in the range of 500 to 2000 MPa.

A method for measuring the Young's modulus of the ribbon layer 101 is as follows. The ribbon layer 101 scraped off using an unused blade is subjected to state adjustment at a constant temperature and humidity (23° C., 50%), and then a sample piece having a length of 25 mm is prepared. Next, under the condition of constant temperature and constant humidity (23° C., 50%), the sample is pulled at a pulling rate of 1 mm/min, and the force at the time of 2.5% stretching is measured. Then, the elastic modulus of the ribbon layer 101 is calculated based on the measured force at the time of stretching. The cross-sectional area of the sample piece is measured with a microscope. In general, the Young's modulus of the ribbon layer 101 may be in the range of 1.0 to 2000 MPa.

In the present embodiment, an optical fiber having an effective core cross-sectional area (effective core cross-sectional area) Aeff of 60 μm² or more (≥60 μm²) is used as the optical fiber. In the optical fiber, Aeff is an index of microbend sensitivity, and a larger Aeff indicates a higher microbend sensitivity. In general, when the effective core cross-sectional area exceeds 100 μm², it is said that the microbend sensitivity is high. In particular, when Aeff is equal to or greater than 130 μm² and equal to or less than 150 μm², the optical fiber has high microbend sensitivity without any problem. The effective core cross-sectional area (effective core cross-sectional area) Aeff is expressed by (MFD)²×π×k/4 (Here, MFD is a mode field diameter (μm), and k is a constant.), and is described in, for example, C-3-76 and C-3-77 of the Institute of Electronics and Communications Engineers of Electronics and Society of Electronics and Communications, 1999. It is also assumed that Aeff is measured at 1550 nm.

There are various methods of measuring microbend loss. In the present specification, A microbend loss value defines a difference between a transmission loss of an optical fiber to be measured in a state A in which optical fibers having a length of greater than or equal to 400 m are wound around a large bobbin wound a sandpaper #1000 thereon in one layer so as not to overlap each other with a tension of 100 gf, and a transmission loss of an optical fiber in state B wound on the same bobbin as state A with the same tension and length as state A in which the sandpaper is not wound around the bobbin. Here, the transmission loss of the optical fiber in the state B does not include the microbend loss, and is considered to be a transmission loss inherent to the optical fiber itself.

This measuring method is similar to the fixed diameter drum method defined in JIS C6823:2010. This measuring method is also referred to as a sandpaper method. For example, transmission loss is measured at a wavelength of 1550 nm.

### EXAMPLES

Next, Examples 1-6 and Comparative Examples 1-2 of the coated optical fiber 6 according to the present invention will be described. In Examples 1-6 and Comparative Examples 1-2, a delamination recovery test was performed by the following method. First, partial peeling (delamination) was caused by applying a local load to the side surface of the coated optical fiber 6. Thereafter, the optical fiber was stored in an atmosphere at a temperature of 23° C. and a relative humidity of 50%, and the state of delamination with time was observed with a microscope. The delamination recovery test was performed after one month or more had elapsed after the optical fiber was drawn.

In Examples 1-6 and Comparative Examples 1-2, a pull-out force test was performed by the following method. First, one end of an optical fiber from which a covering layer was stripped off by several mm by using a commercially available stripper was fixed to one of two sheets of sandpaper (10 mmx 50 mm) arranged 10 cm apart by an adhesive. In addition, another end of the optical fiber was fixed to the other piece of sandpaper with the adhesive. The prepared sample was stored overnight in an atmosphere at a temperature of 23° C. and a relative humidity of 50%, and the sample was pulled at a pulling rate of 5 mm/min, and the maximum applied load was read. Note that the pull-out force test was performed after one month or more after the optical fiber was drawn.

Further, in Examples 1-6 and Comparative Examples 1-2, a critical adhesion force test was performed by the following method. First, one end of an optical fiber from which a covering layer was stripped off by several mm using a commercially available stripper was fixed to one of two sheets of sandpaper (10 mm×50 mm) arranged at a distance of 21 cm apart by an adhesive. In addition, the other end of the optical fiber was fixed to the other piece of sandpaper with the adhesive. Next, a load of 30 to 180 g was applied to the prepared sample under high temperature and high humidity (constant at 60° C. and 98%), and the time from the application until the optical fiber dropped was recorded. The applied load was plotted against the time until the optical fiber dropped. Among the plurality of applied loads plotted, the applied load as the Knee point was defined as the critical adhesion force.

In Examples 1-6 and Comparative Examples 1-2, any one of the silane coupling agent A, the silane coupling agent B, and the silane coupling agent C having the following chemical formula was added to the common ultraviolet curing resin (urethane acrylate). The silane coupling agent A was a compound synthesized using 1,6-hexanediol (manufactured by Tokyo Chemical Industry Co., Ltd.) and 3-isocyanatopropyltrimethoxysilane (manufactured by Tokyo Chemical Industry Co., Ltd.) as raw materials. The silane coupling agent B was a compound synthesized using polypropylene glycol (Mn to 1000, manufactured by SIGMA-ALDRICH) and 3-isocyanatopropyltrimethoxysilane (manufactured by Tokyo Chemical Industry Co., Ltd.) as raw materials. The silane coupling agent C was a commercially available silane coupling agent (manufactured by Tokyo Chemical Industry Co., Ltd.).

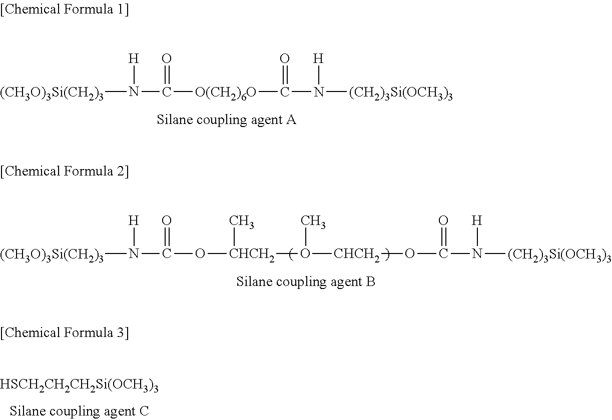

The diol is not limited to (1,6-hexanediol) and polypropylene glycol, and may be, for example, (1,7-heptanediol) and polyethylene glycol. In the case of an oligomer polymer such as polypropylene glycol or polyethylene glycol, the molecular weight is not particularly limited. Each of the silane coupling agent A and the silane coupling agent B includes a portion in which a urethane bond is formed in a molecular structure. Therefore, the portion where the urethane bond is formed in the ultraviolet curing resin constituting the primary layer 3, and the portion where the urethane bond is formed in the silane coupling agent form a hydrogen bond. The hydrogen bond is easily cleaved under high temperature or high humidity. In addition, since the hydrogen bond is cut, the critical adhesive force is lowered. That is, when the extraction force is sufficiently high, and the critical adhesion force is low, it can be considered that the bare optical fiber 2 and the primary layer 3 are in close contact with each other by a hydrogen bond.

In Examples 1-6, a silane coupling agent having two urethane in its molecular structure and having methoxysilyl groups at both ends was used, as in the case of the silane coupling agent A or the silane coupling agent B, but the molecular structure of the silane coupling agent is not limited to this structure. The molecular structure of the silane coupling agent may be any as long as it has a functional group that forms one or more reversible bonds between the bare optical fiber 2 and the primary layer 3, as illustrated in the following chemical formula. In the following chemical formula, x represents an integer of 1 to 3. Y represents an integer of 0 to 2. X+y≤3. R¹ represents an alkoxy group, an acetoxy group, or a halogen group. R² represents H or CH₃. R³ represents a molecular chain containing a functional group which partially forms one or more reversible bonds between the bare optical fiber 2 and the primary layer 3. R³ may include, for example, a functional group such as an alkoxysilyl group, an acetoxysilyl group, or a halosilyl group.

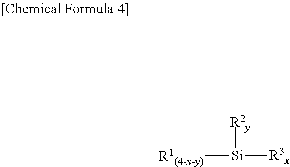

The equivalent (K) of the portion where the bare optical fiber 2 and the primary layer 3 form the reversible bond is calculated according to the following equation (2). Here, N represents the number of portions where the bare optical fiber 2 and the primary layer 3 form the reversible bond in one molecule of the silane coupling agent. Wt represents the mass of the silane coupling agent per 100 g of the ultraviolet curing resin composition forming the primary layer 3. Mn is the theoretical molecular weight of the silane coupling agent.

K=(N*Wt)/Mn equation (2)

For example, in the case of the silane coupling agent A, N=2 and Mn=528.8 g/mol because of the molecular structure having two urethane bonds. In the case of the silane coupling agent B, N=2 and Mn=1328.5 g/mol because of the molecular structure having two urethane bonds.

The conditions (type, addition amount, and equivalent) of the silane coupling agent and the results of various tests on the coated optical fiber 6 in Examples 1-6 and Comparative Examples 1-2 are illustrated in Table 1 below.

TABLE 1

| | | | | Optical fiber | | |
|---|---|---|---|---|---|---|
| | | | | | Pull- | Critical |
| | Additive | | | | out | adhesion |
| | Silane coupling agent | | | Delamination recovery test | force | force |
| | — | wt % | Equivalent | — | N | N |
| Example 1 | A | 0.10 | 0.00038 | Higher degree of recovery than | 1.83 | 0.49 |
| | | | | Comparative Examples 1 and 2 | | |
| Example 2 | A | 0.67 | 0.0025 | Higher degree of recovery than | 5.46 | 0.88 |
| | | | | Comparative Examples 1 and 2 | | |
| Example 3 | A | 2.02 | 0.0076 | Higher degree of recovery than | 14.74 | 1.37 |
| | | | | Comparative Examples 1 and 2 | | |
| Example 4 | B | 0.42 | 0.00063 | Higher degree of recovery than | 2.82 | 0.49 |
| | | | | Comparative Examples 1 and 2 | | |
| Example 5 | B | 1.69 | 0.0025 | Higher degree of recovery than | 2.80 | 0.49 |
| | | | | Comparative Examples 1 and 2 | | |
| Example 6 | B | 5.07 | 0.0076 | Higher degree of recovery than | 3.45 | 0.88 |
| | | | | Comparative Examples 1 and 2 | | |
| Comparative | C | 0.20 | — | — | 1.77 | 0.49 |
| Example 1 | | | | | | |
| Comparative | C | 0.50 | — | — | 3.74 | 1.37 |
| Example 2 | | | | | | |

### Example 1

In the coated optical fiber 6 of Example 1, the primary layer 3 was formed using a primary layer material in which 0.10 wt % of the silane coupling agent A was added to the ultraviolet curing resin (urethane acrylate). In the coated optical fiber 6 of Example 1, the degree of recovery of delamination was higher than that of the optical fiber using the silane coupling agent C (Comparative Example 1 and Comparative Example 2). In addition, the pull-out force in the coated optical fiber 6 of Example 1 was 1.83 N, and the critical adhesion force was 0.49 N. It is considered that the bare optical fiber 2 and the primary layer 3 are bonded to each other by hydrogen bond in the coated optical fiber 6 because the critical adhesion force is low with respect to the extraction force.

### Example 2

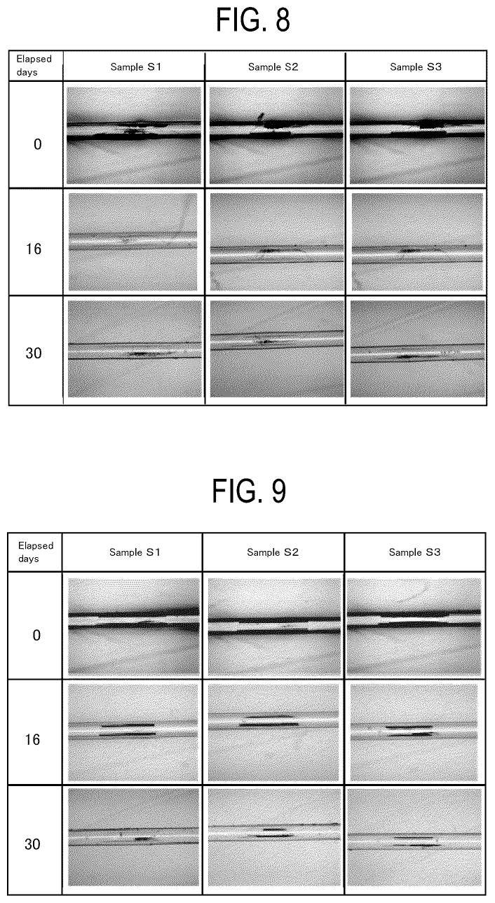

In the coated optical fiber 6 of Example 2, the primary layer 3 was formed using a primary layer material in which 0.67 wt % of the silane coupling agent A was added to the ultraviolet curing resin (urethane acrylate). In the coated optical fiber 6 of Example 2, the degree of recovery of delamination was higher than that of the optical fiber using the silane coupling agent C (Comparative Example 1 and Comparative Example 2). FIG. 8 is a graph illustrating the results of a delamination recovery test in Example 2. Here, the states of the three samples S1 to S3 when 0 days, 16 days, and 30 days have elapsed after the delamination is formed are illustrated. Delamination occurs in a portion indicated by black in FIG. 8. In the samples S1 to S3, it was observed that the delamination was recovered with the passage of days. In the coated optical fiber 6 of Example 2, the pull-out force was 5.46 N, and the critical adhesion force was 0.88 N. It is considered that the bare optical fiber 2 and the primary layer 3 are bonded to each other by hydrogen bond in the coated optical fiber 6 because the critical adhesion force is low with respect to the extraction force.

### Example 3

In the coated optical fiber 6 of Example 3, a primary layer was formed using a primary layer material in which 2.02 wt % of the silane coupling agent A was added to the ultraviolet curing resin (urethane acrylate). In the coated optical fiber 6 of Example 3, the degree of recovery of delamination was higher than that of the optical fiber using the silane coupling agent C (Comparative Example 1 and Comparative Example 2). In the coated optical fiber 6 of Example 3, the pull-out force was 14.74 N, and the critical adhesion force was 1.37 N. It is considered that the bare optical fiber 2 and the primary layer 3 are bonded to each other by hydrogen bond in the coated optical fiber 6 because the critical adhesion low with respect to the extraction force.

### Example 4

In the coated optical fiber 6 of Example 4, the primary layer 3 was formed using a primary layer material in which 0.42 wt % of the silane coupling agent B was added to the ultraviolet curing resin (urethane acrylate). In the coated optical fiber 6 of Example 4, the degree of recovery of delamination was higher than that of the optical fiber using the silane coupling agent C (Comparative Example 1 and Comparative Example 2). In the coated optical fiber 6 of Example 4, the pull-out force was 2.82 N, and the critical adhesion force was 0.49 N. It is considered that the bare optical fiber 2 and the primary layer 3 are bonded to each other by hydrogen bond in the coated optical fiber 6 because the critical adhesion force is low with respect to the extraction force.

### Example 5

In the coated optical fiber 6 of Example 5, the primary layer 3 was formed using a primary layer material in which 1.69 wt % of the silane coupling agent B was added to the ultraviolet curing resin (urethane acrylate). In the coated optical fiber 6 of Example 5, the degree of recovery of delamination was higher than that of the optical fiber using the silane coupling agent C (Comparative Example 1 and Comparative Example 2). In the coated optical fiber 6 of Example 5, the pull-out force was 2.80 N, and the critical adhesion force was 0.49 N. It is considered that the bare optical fiber 2 and the primary layer 3 are bonded to each other by hydrogen bond in the coated optical fiber 6 because the critical adhesion force is low with respect to the extraction force.

### Example 6

In the coated optical fiber 6 of Example 6, the primary layer 3 was formed using a primary layer material in which 5.07 wt % of the silane coupling agent B was added to the ultraviolet curing resin (urethane acrylate). In the coated optical fiber 6 of Example 6, the degree of recovery of delamination was higher than that of the optical fiber using the silane coupling agent C (Comparative Example 1 and Comparative Example 2). In the coated optical fiber 6 of Example 6, the pull-out force was 3.45 N, and the critical adhesion force was 0.88 N. It is considered that the bare optical fiber 2 and the primary layer 3 are bonded to each other by hydrogen bond in the coated optical fiber 6 because the critical adhesion force is low with respect to the extraction force.

### Comparative Example 1

In the coated optical fiber 6 of Comparative Example 1, the primary layer 3 was formed using a primary layer material in which 0.20 wt % of the silane coupling agent C was added to the ultraviolet curing resin (urethane acrylate). In the coated optical fiber 6 of Comparative Example 1, the pull-out force was 3.74 N, and the critical adhesion force was 1.37 N. In the coated optical fiber 6 of Comparative Example 1, unlike the case of Examples 1-6, sufficient recovery of delamination was not confirmed.

### Comparative Example 2

In the coated optical fiber 6 of Comparative Example 2, the primary layer 3 was formed using a primary layer material in which 0.50 wt % of the silane coupling agent C was added to the ultraviolet curing resin (urethane acrylate). FIG. 9 is a graph illustrating the results of a delamination recovery test in Comparative Example 2. Here, the states of the three samples S1 to S3 when 0 days, 16 days, and 30 days have elapsed after the delamination is formed are illustrated. Delamination occurs in a portion indicated by black in FIG. 9. In the samples S1 to S3, it was observed that the delamination was recovered with the passage of days. However, the recovery of delamination in Comparative Example 2 was slower than that in Example 2. In the coated optical fiber 6 of Comparative Example 2, the pull-out force was 1.77 N, and the critical adhesion force was 0.49 N. In the coated optical fiber 6 of Comparative Example 2, unlike the case of Examples 1-6, sufficient recovery of delamination was not confirmed.

From the above results, it was found that, by reversibly bonding the bare optical fiber 2 and the primary layer 3 of the optical fiber, the recovery force of peeling (delamination) of the primary layer 3 from the bare optical fiber 2 caused by an external stimulus or the like becomes high while sufficiently maintaining the adhesion force between the bare optical fiber 2 and the primary layer 3.

The values of the pull-out force and the critical adhesion force vary depending on the structure (for example, diameter and thickness) of the covering layer in the optical fiber, physical properties such as Young's modulus of the primary layer, the molecular structure of the silane coupling agent (The number of portions for reversibly bonding the bare optical fiber 2 and the primary layer 3 in one molecule.), the amount of the silane coupling agent added, and the like. Therefore, the values of the pull-out force and the critical adhesion force illustrated in Examples 1-6 and Comparative Examples 1-2 are merely examples. In general, the pull-out force may be 1.0 to 20.0 N, and the critical adhesion force may be 0.10 to 3.0 N.

As an example of the reversible bond, the case where the portion where the urethane bond is formed in the ultraviolet curing resin and the portion where the urethane bond is formed in the silane coupling agent are hydrogen-bonded to each other has been described. The reversible bond is not limited solely to hydrogen bonds with urethane bond character. Even when reversible bonds other than hydrogen bonds are used, the degree of recovery of delamination can be increased.

The primary layer 3 includes the ultraviolet curing resin composition in which only the silane coupling agent that reversibly bonds the bare optical fiber 2 and the primary layer 3 is added to the ultraviolet curing resin. However, the composition of the ultraviolet curing resin composition is not limited thereto. An ultraviolet curing resin composition in which another silane coupling agent that irreversibly bonds the bare optical fiber 2 and the primary layer 3 to the ultraviolet curing resin is further added may be used. By using the silane coupling agent that reversibly couples the bare optical fiber 2 and the primary layer 3 and the silane coupling agent that irreversibly couples the bare optical fiber 2 and the primary layer 3 in combination, it is possible to secure the adhesion between the bare optical fiber 2 (glass) and the primary layer 3.

Furthermore, in the above-described Examples and Comparative Examples, it was found that by bonding the optical fiber glass (optical fiber bare wire 2) and the primary layer 3 via hydrogen bonds derived from the urethane bond, external stress causes these hydrogen bonds to break preferentially over other bonds within the optical fiber. The subsequent reformation of hydrogen bonds then restores the adhesion of the primary layer 3. That is, these hydrogen bonds function as sacrificial bonds. By introducing weak bonds between the optical fiber glass and the primary layer 3, external stress can be dissipated as these bonds are cut by the stress. This indicates that the stress applied to the glass is reduced as the external stress dissipates through the cutting of these weak bonds. Note that the term “weak bond” in this specification, as described above, is not limited solely to the reversible bond. The “weak bond” may also be irreversible bond.

Hereinafter, the results of measuring microbend loss using the optical fibers described in the above-mentioned examples and comparative examples are detailed. Here, a simplified microbend loss measurement method was adopted. A 0.28 m length of optical fiber was clamped between rubber (hardness HS70) fitted with mesh (grit #70), and the transmission loss when an 8 kgf load was applied was considered the microbend loss. For this measurement, the average of 10 measurements was used for each level. Note that this measurement was performed simply to compare the relative magnitude of microbend loss; the absolute values of microbend loss should be considered only as a reference.

### Example 1

In Example 1, the primary layer 3 was formed using a primary layer material in which 0.10 wt % of the silane coupling agent A was added to the ultraviolet curing resin (urethane acrylate). The microbend loss of the optical fiber in Example 1 was 0.21 dB/m.

### Example 2

In Example 2, the primary layer 3 was formed using a primary layer material in which 0.67 wt % of the silane coupling agent A was added to the ultraviolet curing resin (urethane acrylate). The microbend loss of the optical fiber in Example 2 was 0.25 dB/m.

### Example 3

In Example 3, the primary layer 3 was formed using a primary layer material in which 2.02 wt % of the silane coupling agent A was added to the ultraviolet curing resin (urethane acrylate). The microbend loss of the optical fiber in Example 3 was 0.25 dB/m.

### Example 4

In Example 4, the primary layer 3 was formed using a primary layer material in which 0.42 wt % of the silane coupling agent B was added to the ultraviolet curing resin (urethane acrylate). The microbend loss of the optical fiber in Example 4 was 0.15 dB/m.

### Example 5

In Example 5, the primary layer 3 was formed using a primary layer material in which 1.69 wt % of the silane coupling agent B was added to the ultraviolet curing resin (urethane acrylate). The microbend loss of the optical fiber in Example 5 was 0.20 dB/m.

### Example 6

In Example 6, the primary layer 3 was formed using a primary layer material in which 5.07 wt % of the silane coupling agent B was added to the ultraviolet curing resin (urethane acrylate). The microbend loss of the optical fiber in Example 6 was 0.20 dB/m.

### Comparative Example 1

In Comparative Example 1, the primary layer 3 was formed using a primary layer material in which 0.20 wt % of the silane coupling agent C was added to the ultraviolet curing resin (urethane acrylate). The microbend loss of the optical fiber in Comparative Example 1 was 0.26 dB/m.

### Comparative Example 2

In Comparative Example 2, the primary layer 3 was formed using a primary layer material in which 0.50 wt % of the silane coupling agent C was added to the ultraviolet curing resin (urethane acrylate). The microbend loss of the optical fiber in Comparative Example 2 was 0.27 dB/m.

As illustrated in Examples 1 to 6, when the primary layer 3 was formed by adding silane coupling agent A or silane coupling agent B, it exhibited lower microbend loss values compared to the cases of Comparative Examples 1 and 2 where silane coupling agent C was added. That is, it was indicated that forming a weak bond (urethane-type hydrogen bond) between the optical fiber glass and the primary layer 3 alleviates the stress applied to the glass, thereby reducing microbend loss.

TABLE 2

| | Additive | | | |
|---|---|---|---|---|
| | Silane coupling agent | | | Microbend loss |
| | — | wt % | Equivalent | dB/m |
| Example 1 | A | 0.10 | 0.00038 | 0.21 |
| Example 2 | A | 0.67 | 0.0025 | 0.25 |
| Example 3 | A | 2.02 | 0.0076 | 0.25 |
| Example 4 | B | 0.42 | 0.00063 | 0.15 |
| Example 5 | B | 1.69 | 0.0025 | 0.20 |
| Example 6 | B | 5.07 | 0.0076 | 0.20 |
| Comparative Example 1 | C | 0.20 | — | 0.26 |
| Comparative Example 2 | C | 0.50 | — | 0.27 |

Furthermore, the term “weak bond” in this specification is not limited to hydrogen bonds. For example, polymer materials incorporating the BiTEMPS skeleton have been reported to exhibit enhanced stress relaxation effects (A. Takahashi, R. Goseki, K. Ito, H. Otsuka, ACS Macro Lett. 2017, 6, 1280.). Furthermore, polymer materials incorporating the DESN skeleton have also been reported to exhibit enhanced stress relaxation effects (H. Sakai, D. Aoki, K. Seshiimo, K. Mayumi, S. Nishitsuji, T. Kurose, H. Ito, H. Otsuka, ACS Macro Lett. 2020, 9, 1108). The bond energy of the S—S bond in the center of BiTEMPS skeleton is 130 kJ/mol, while the bond energy of the C—C bond in the center of DFSN skeleton is 100 kJ/mol. This indicates that both possess lower bond energies compared to the typical C—C bond energy of 347 kJ/mol. That is, introducing a compound with a bond energy of 130 kJ/mol or less at the interface between the optical fiber bare wire 2 and the primary layer 3 (hereinafter referred to as the “first interface”) can be expected to reduce microbend loss.

Bond energy refers to the energy required to break a chemical bond. Generally, bond energy is expressed in units of kJ/mol. Methods for calculating bond energy include the van 't Hoff equation, which calculates bond energy based on the relationship between the dissociation percentage of the bond in a heated sample containing that bond and the heating temperature, and methods using molecular orbital calculation software.

Furthermore, the interface where the weak bond can be introduced is not limited to the first interface. In the optical fiber, a weak bond can also be introduced at the interface between the primary layer 3 and the secondary layer 4 (hereinafter, this is referred to as the “second interface”). The type of weak bond introduced at the second interface may be the same as or different from the type introduced at the first interface. That is, in the optical fiber, at least one type of chemical bond (weak bond) possessing the aforementioned coupling energy may be introduced to at least one of the first and second interfaces.

In the colored optical fiber 1 having a colored layer 5, the weak bond may also be introduced at the interface between the secondary layer 4 and the colored layer 5 (hereinafter, this is referred to as the “third interface”). The type of weak bond introduced at the third interface may be the same as or different from the type introduced at the other interfaces. That is, in the colored optical fiber 1, at least one type of the aforementioned weak bond may be introduced to at least one of the first interface, the second interface, and the third interface.

Furthermore, when a plurality of colored optical fibers 1 having a colored secondary layer 4 are arranged in parallel to form an optical fiber ribbon 100, weak bonds may also be introduced at the interface between the secondary layer 4 and the ribbon layer 101 (hereinafter, this is referred to as the “fourth interface”). The type of weak bonds introduced at the fourth interface may be the same as or different from the types introduced at the other interfaces. In the optical fiber ribbon 100, at least one type of weak bond may be introduced to at least one of the first interface, the second interface, and the fourth interface.

Furthermore, when a plurality of colored optical fibers 1 having a colored layer 5 are arranged in parallel to form an optical fiber ribbon 100, weak bonds may also be introduced at the interface between the colored layer 5 and the ribbon layer 101 (hereinafter, this is referred to as the “fifth interface”). The type of weak bonds introduced at the fifth interface may be the same as or different from the types introduced at the other interfaces. In the optical fiber ribbon 100, at least one type of weak bond may be introduced to at least one of the first interface, second interface, third interface, and fifth interface.

Furthermore, the weak bonds introduced at a single interface are not limited to just one type. For example, two types of weak bonds may be introduced at the first interface. That is, at least one type of weak bond may be introduced at each interface.

Furthermore, when multiple optical fiber ribbons are integrally connected by a UV-curable resin-based bonding layer (not illustrated), weak bonds may also be introduced at the interface between the ribbon layer 101 of each ribbon and the bonding layer. Similarly, in a structure where the optical fiber has only a primary layer 3 as a covering layer, weak bonding is introduced at the interface (first interface) between the optical fiber bare wire 2 (glass) and the primary layer 3. An advantage of introducing weak bonding at the interface between adjacent different covering layers is that it enables efficient stress transfer between layers of differing hardness.

Furthermore, it is expected that stress relaxation effects can also be achieved by introducing weak bonds within the covering layer (the bulk), outside the interface. Research introducing BiTEMPS and DFSN, as mentioned above, demonstrates stress relaxation effects by introducing them into the bulk of polymer materials, thereby substantiating the stress relaxation effect. Furthermore, the type of weak bond (hereinafter, this is referred to as the “first chemical bond”) introduced at the interface of the covering layer may be the same as or different from the type of weak bond (hereinafter, this is referred to as the “second chemical bond”) introduced within the covering layer (the bulk). The type of weak bond introduced into each bulk region can be appropriately modified.

Furthermore, weak bonds may be introduced either at the interface or within the covering layer (the bulk), or at both the interface and within the covering layer (the bulk). Even when the first chemical bond is introduced at the interface and the second chemical bond is introduced within the covering layer, the weak bond introduced at a single interface is not limited to just one type. Similarly, weak bonds introduced within multiple covering layers are not limited to just one type.

For optical fibers, the type of weak bond introduced within the primary layer 3 may be the same as or different from the type introduced within the secondary layer 4. That is, for optical fibers, at least one type of weak bond (second chemical bond) may be introduced into at least one of the primary layer 3 and the secondary layer 4.

Similarly, in the colored optical fiber 1, the type of weak bond introduced into the coloring layer 5 or the colored secondary layer 4 may be the same as or different from the type of weak bond introduced into the other covering layers. That is, in the case of the colored optical fiber 1 having a coloring layer 5, at least one type of weak bond may be introduced within at least one of the primary layer 3, the secondary layer 4, and the coloring layer 5. In the case of the colored optical fiber 1 having a colored secondary layer 4, weak bond may be introduced within at least one of the primary layer 3 and the secondary layer 4.

Furthermore, in the optical fiber ribbon 100, weak bonds may also be introduced within the ribbon layer 101. The type of chemical bond introduced within the ribbon layer 101 may be the same as or different from the type of chemical bond introduced within other covering layers. When the optical fiber ribbon 100 is formed by arranging multiple colored optical fibers 1, which have a colored secondary layer 4, in parallel, weak bonds (second chemical bonds) may be introduced within at least one of the primary layer 3, the secondary layer 4, and the ribbon layer 101, with at least one type being introduced.

Furthermore, when a plurality of colored optical fibers 1 having a colored layer 5 are arranged in parallel to form an optical fiber ribbon 100, at least one type of weak bond (second chemical bond) may be introduced within at least one of the primary layer 3, the secondary layer 4, the colored layer 5, and the ribbon layer 101.

Furthermore, in covering layers primarily composed of urethane acrylates, hydrogen bond is already thought to exert a stress-relaxing effect as a weak bond. Therefore, by introducing additional weak bonds beyond hydrogen bonds, it is expected that a stress-relaxing effect from the newly introduced weak bonds can be obtained, in addition to the stress-relaxing effect from hydrogen bond.

Furthermore, hydrogen bonds are easily cut by high temperatures or high humidity. Moreover, if the molecular chain arrangement within the covering layer changes during cutting, it may not necessarily revert to its original bonded state even after the high-temperature or high-humidity environment subsides. This could potentially alter the bulk properties and stress relaxation effect of the covering layer. Considering this, introducing weak bonds other than hydrogen bonds within the covering layer offers the advantage of further stabilizing the bulk properties and stress relaxation effect. For weak bonds other than hydrogen bonds, it is required that they do not break as easily as hydrogen bonds.

TABLE 3

| | Bond energy |
|---|---|
| Type of chemical bond | [kJ/mol] |
| C—C | 347 |
| C—H | 413 |
| C—Si | 360 |
| Si—O | 452 |
| C—S | 259 |
| C—N | 305 |
| N—H | 391 |
| C—O | 358 |
| C═O | 724 |
| S—S bond in the center of BiTEMPS | 130 |
| C—C bond in the center of DFSN | 100 |
| Urethane-type hydrogen bond | 16 |
| Hydrogen bond | 8 |

The term “interface” in this specification indicates the boundary between the surface of the bare optical fiber 2 and the surface of the primary layer 3, or between the surfaces of adjacent different covering layers (however, the term “interface” also includes the surface of the covering layer). That is, when bonding the optical fiber bare wire 2 and the covering layer using a silane coupling agent, the bonds involving atoms contained in the silane coupling agent at the “interface” between the bare optical fiber 2 and the covering layer constitute the bonds included within the “interface”. On the other hand, “within the covering layer” in this specification refers to the portion other than the surface of the covering layer.

Specifically, when the interface between the bare optical fiber 2 and the covering layer is bonded with silane coupling agent A, the bonds introduced at the “interface” include urethane-type hydrogen bonds, C—C bonds, C—H bonds, C—N bonds, N—H bonds, C—O bonds, C═O bonds, C—Si bonds, and Si—O bonds. When the covering layer is composed of urethane acrylate, the bonds present “within the covering layer” include urethane-type hydrogen bonds, C—C bonds, C—H bonds, C—N bonds, N—H bonds, C—O bonds, and C═O bonds. Furthermore, if additives are incorporated into the covering layer, or if urethane acrylates forming chemical bonds other than those listed above are used, chemical bonds not listed above will also be included within the “inside of the covering layer”. For example, when adding isooctyl 3-mercaptopropionate as a chain transfer agent to the covering layer, C—S bonds are formed in addition to the bonds listed above.

Specifically, when the interface between the bare optical fiber and the covering layer is bonded with silane coupling agent C, the bonds introduced at the “interface” are C—S bonds, C—C bonds, C—H bonds, C—Si bonds, and Si—O bonds. When the covering layer is composed of urethane acrylate, the bonds present “within the covering layer” include urethane-type hydrogen bonds, C—C bonds, C—H bonds, C—N bonds, N—H bonds, C—O bonds, C═O bonds, C—Si bonds, Si—O bonds, and C—S bonds. It is assumed that a cross-linked structure derived from silane coupling agent C is present “within the covering layer”. Furthermore, if additives are incorporated into the covering layer or if urethane acrylates forming chemical bonds other than those listed above are used, chemical bonds other than those listed above will also be included “within the covering layer”.

Stress relaxation effects are expected to be enhanced by introducing chemical bonds weaker than those typically found at least at one of the following locations: the interface between the optical fiber glass and the primary layer 3 (first interface); the interface between different covering layers (second to fifth interfaces); or within the covering layers themselves. An indicator of weak bonds is, for example, a bond energy below 259 kJ/mol, which is the bond energy of the C—S bond-the weakest bond among those typically present. To achieve a higher stress relaxation effect, it is preferable that the weak bond has bond energy equal to or less than that of the central S—S bond in the BiTEMPS skeleton (130 kJ/mol). Introducing such weak bonds at “interfaces” or inside covering layers enables the achievement of a stress relaxation effect.

Weak bonds can achieve the aforementioned stress relaxation effect, and if these weak bonds are reversible, the stress relaxation effect can be obtained repeatedly. Furthermore, beyond the bonds illustrated in Table 3, structures capable of dissipating external stress may include ionic bonds, intermolecular forces strong enough to affect material strength (indicated by bond energies equal to or greater than hydrogen bond energy, yet less than C—S bond energy), and entanglement of molecular chains (indicated by bond energies equal to or greater than hydrogen bond energy, yet less than C—S bond energy). In these cases as well, similar stress relaxation effects are expected.

The present invention is not limited to the above-described embodiments, and various modifications are possible. For example, an example in which a part of the configuration of any of the embodiments is added to another embodiment, and an example in which a part of the configuration of another embodiment is replaced with another embodiment, are also embodiments of the present invention. In addition, a well-known technique or a publicly known technique in the technical field can be appropriately applied to a portion that is not particularly described or illustrated in the embodiment.

For example, the above embodiment described the stress relaxation effects of the colored optical fibers having a multi-layer covering configuration including the primary layer 3 and the secondary layer 4. However, even in an optical fiber comprising the bare optical fiber 2 and a single covering layer covering the bare optical fiber 2, sufficient stress relaxation effects can be achieved by introducing a weak bond at the interface between the bare optical fiber 2 and the covering layer.

What is claimed is:

1. An optical fiber comprising:
a bare optical fiber;
a primary layer that is formed of a first ultraviolet curing resin composition and covers the bare optical fiber; and
a secondary layer that is formed of a second ultraviolet curing resin composition and covers the primary layer,
wherein at least one type of chemical bond with a bond energy of less than 259 kJ/mol is introduced into at least one of a first interface between the bare optical fiber and the primary layer, and a second interface between the primary layer and the secondary layer.

2. An optical fiber comprising:
a bare optical fiber;
a primary layer that is formed of a first ultraviolet curing resin composition and covers the bare optical fiber; and
a secondary layer that is formed of a second ultraviolet curing resin composition and covers the primary layer,
wherein at least one type of chemical bond with a bond energy of less than 259 kJ/mol is introduced into within at least one of the primary layer and the secondary layer.

3. An optical fiber comprising:
a bare optical fiber;
a primary layer that is formed of a first ultraviolet curing resin composition and covers the bare optical fiber; and
a secondary layer that is formed of a second ultraviolet curing resin composition and covers the primary layer,
wherein at least one type of first chemical bond with a bond energy of less than 259 kJ/mol is introduced into at least one of a first interface between the bare optical fiber and the primary layer, and a second interface between the primary layer and the secondary layer, and
wherein at least one type of second chemical bond with a bond energy of less than 259 kJ/mol is introduced within at least one of the primary layer and the secondary layer.

4. A colored optical fiber comprising:
the optical fiber according to claim 1,
wherein the secondary layer is colored.

5. A colored optical fiber comprising:
the optical fiber according to claim 1; and
a colored layer that covers the secondary layer.

6. An optical fiber ribbon comprising:
a plurality of the colored optical fibers according to claim 4; and
a ribbon layer that covers the plurality of the optical fibers arranged in parallel and that connects the plurality of the colored optical fibers.

7. An optical fiber ribbon comprising:
a plurality of the colored optical fibers according to claim 5; and
a ribbon layer that covers the plurality of the optical fibers arranged in parallel and that connects the plurality of the colored optical fibers.

8. The optical fiber according to claim 1, wherein the bond energy of the chemical bond is less than 130 kJ/mol.

9. The optical fiber according to claim 3, wherein the bond energies of the first chemical bond and the second chemical bond are less than 130 kJ/mol.

10. The optical fiber according to claim 1, wherein the chemical bond is preferentially cut by external stress compared to other chemical bonds included in the optical fiber.

11. The optical fiber according to claim 3, wherein the first chemical bond and the second chemical bond are preferentially cut by external stress compared to other chemical bonds included in the optical fiber.
